(19) United States
(12) Patent Application Publication
(10) Pub. No.: US 2016/0319722 A1
(43) Pub. Date: Nov. 3, 2016

(54) CATALYTIC CONVERTER AND METHOD FOR DESIGNING THE CATALYTIC CONVERTER

(71) Applicant: TOYOTA JIDOSHA KABUSHIKI KAISHA, Toyota-shi, Aichi (JP)

(72) Inventors: Yuki AOKI, Aichi (JP); Takahiko FUJIWARA, Shizuoka (JP); Ryosuke KAYANUMA, Shizuoka (JP); Yuji YABUZAKI, Shizuoka (JP); Naohiro HAYASHI, Aichi (JP); Hiroyuki MATSUBARA, Gifu (JP)

(73) Assignee: Toyota Jidosha Kabushiki Kaisha, Toyota-shi, Aichi (JP)

(21) Appl. No.: 14/648,559

(22) PCT Filed: Dec. 16, 2014
(86) PCT No.: PCT/JP2014/084201

§ 371 Date: May 29, 2015

(30) Foreign Application Priority Data
Jan. 24, 2014 (JP) 2014-011106

(51) Int. Cl. F01N 3/28; B01J 35/00; B01J 35/04; B01D 53/94; G06F 17/50

(52) U.S. Cl. CPC F01N 3/2828; B01D 53/94; G06F 17/5086; B01J 35/04; B01J 35/0006; F01N 2330/06; F01N 2330/48; B01D 2255/9022; B01D 2255/92

(57) ABSTRACT

A catalytic converter capable of uniformizing an exhaust gas flow velocity to realize uniform temperature distribution and improved purification performance, and a method for designing the catalytic converter. A catalytic converter includes a catalyst base composed of an inner base material part having inner cell holes and an outer base material part having outer cell holes, and an exhaust pipe composed of an upstream-side pipe, a catalyst housing pipe and a downstream-side pipe. In the catalytic converter, a flow path cross-sectional area of the upstream-side pipe defined as S1, a cross-sectional area of the inner base material part defined as S2, a cross-sectional area of the catalyst base defined as S3, a hydraulic diameter of the inner cell holes defined as d1 and a hydraulic diameter of the outer cell holes defined as d2, satisfy the relationship, S1≦S2≦S3(−0.2242 (d1²/d2²)²+0.1141 (d1²/d2²)+0.617).

### TECHNICAL FIELD

The present invention relates to a catalytic converter for purifying an exhaust gas, and a method for designing the catalytic converter.

### BACKGROUND ART

As a catalytic converter for purifying an exhaust gas in an internal combustion engine of an automobile or the like, a catalytic converter has been known in which a catalyst base having a plurality of cell walls arranged in a lattice pattern and a plurality of cell holes formed so as to be surrounded by the cell walls is disposed inside an exhaust pipe that allows an exhaust gas to flow therethrough. In the catalytic converter, a high-temperature exhaust gas flowing through the cell holes of the catalyst base activates supported catalyst whereby the exhaust gas is purified. In the catalytic converter, a flow rate of the exhaust gas toward the center of the catalyst base tends to be high, while a flow rate of the exhaust gas toward the periphery of the catalyst base tends to be low.

Patent Literature 1 discloses an example of a catalyst base used in such a catalytic converter. In the catalyst base disclosed in Patent Literature 1, the amount of a catalyst supported at a center part of the catalyst base where the flow rate of an exhaust gas is high is increased as compared to the amount of a catalyst supported at a peripheral part thereof, thereby to improve purification performance.

### CITATION LIST

### Patent Literature

Patent Literature 1: JP-A-2002-177794

### SUMMARY OF INVENTION

### Technical Problem

The catalyst base disclosed in Patent Literature 1 has the following problems.

In the catalyst base disclosed in Patent Literature 1, although purification performance is improved by increasing the amount of the catalyst supported at the center part, non-uniformity in the flow rate of the exhaust gas between the center part and the peripheral part of the catalyst base remains unsolved. In the catalyst base, such non-uniformity in the flow rate of the exhaust gas causes the center part where the flow rate of the exhaust gas is high to have a high temperature, and the peripheral part where the flow rate of the exhaust gas is low to have a lower temperature than the center part. Consequently, in the low-temperature part, the catalyst may take more time to reach an activation temperature, or may not reach the activation temperature. As a result, purification performance in the catalyst base is degraded.

The present invention has been made in view of the above background, and provides a catalytic converter capable of making a flow velocity of a flowing exhaust gas uniform to realize uniform temperature distribution and improved purification performance, and a method for designing the catalytic converter.

### Solution to Problem

One aspect of the present invention relates to a method for designing a catalytic converter, the catalytic converter including: a catalyst base including an inner base material part and an outer base material part, the inner base material part including inner cell holes that allow an exhaust gas to flow therethrough, and the outer base material part being formed outside the inner base material part and including outer cell holes each with a hydraulic diameter larger than that of the inner cell holes; and an exhaust pipe including an upstream-side pipe, a catalyst housing pipe and a downstream-side pipe, the upstream-side pipe allowing an exhaust gas generated in an internal combustion engine to flow therethrough, the catalyst housing pipe communicating with the upstream-side pipe, having a diameter larger than that of the upstream-side pipe and housing the catalyst base, and the downstream-side pipe being disposed downstream of the catalyst housing pipe and allowing the exhaust gas purified by the catalyst base to flow therethrough, the method including the step of determining dimensions of a flow path cross-sectional area of the upstream-side pipe defined as S1, a cross-sectional area of the inner base material part defined as S2, a cross-sectional area of the catalyst base defined as S3, a hydraulic diameter of the each inner cell hole defined as d1 and a hydraulic diameter of the each outer cell hole defined as d2 so as to satisfy the relationship of S1≦S2≦S3(−0.2242(d1²/d2²)²+0.1141(d1²/d2²)+0.617).

Another aspect of the present invention relates to a catalytic converter including: a catalyst base including an inner base material part and an outer base material part, the inner base material part including inner cell holes that allow an exhaust gas to flow therethrough, and the outer base material part being formed outside the inner base material part and including outer cell holes each with a hydraulic diameter larger than that of the inner cell holes; and an exhaust pipe including an upstream-side pipe, a catalyst housing pipe and a downstream-side pipe, the upstream-side pipe allowing an exhaust gas generated in an internal combustion engine to flow therethrough, the catalyst housing pipe communicating with the upstream-side pipe, having a diameter larger than that of the upstream-side pipe and housing the catalyst base, and the downstream-side pipe being disposed downstream of the catalyst housing pipe and allowing the exhaust gas purified by the catalyst base to flow therethrough, wherein a flow path cross-sectional area of the upstream-side pipe defined as S1, a cross-sectional area of the inner base material part defined as S2, a cross-sectional area of the catalyst base defined as S3, a hydraulic diameter of the each inner cell hole defined as d1 and a hydraulic diameter of the each outer cell hole defined as d2, satisfy the relationship of S1≦S2≦S3(−0.2242(d1²/d2²)²+0.1141(d1²/d2²)+0.617).

### Advantageous Effects of Invention

The above-described catalytic converter and method for designing the catalytic converter provide the relational expression to appropriately determine the cross-sectional area of the inner base material part of the catalyst base.

Specifically, the dimensions of the flow path cross-sectional area S1 of the upstream-side pipe, the cross-sectional area S2 of the inner base material part, the cross-sectional area S3 of the catalyst base, the hydraulic diameter d1 of the inner cell holes, and the hydraulic diameter d2 of the outer cell holes are determined so as to satisfy the relational expression of S1≦S2≦S3(−0.2242(d1²/d2²)²+0.1141(d1²/d2²)+0.617). By satisfying the relational expression, the dimensions of S1, S2, S3, d1 and d2 are determined in a balanced manner, and distribution of the flow velocity of the exhaust gas flowing through the catalyst base can be made uniform. Thereby, temperature distribution in the catalyst base can be made uniform, and the temperature of the entirety of the catalyst base can be rapidly raised to the activation temperature.

Thus, designing a catalytic converter in such a manner as to satisfy the above relational expression enables to provide an aforesaid catalytic converter appropriate for efficiently purifying the exhaust gas.

Thus, the above-described method for designing the catalytic converter can provide the catalytic converter capable of making distribution of the flow velocity of the exhaust gas uniform, and efficiently purifying the exhaust gas.

### BRIEF DESCRIPTION OF DRAWINGS

FIG. 1 is a partial cross-sectional view of a catalytic converter according to Example 1.

FIG. 2 is a cross-sectional view of a catalyst base according to Example 1 (as viewed in the direction of an arrow II in FIG. 1).

FIG. 3 is a graph showing a relationship between a variation in flow velocity and a cross-sectional area ratio in Confirmation Test 1.

FIG. 4 is a graph showing a relationship between a cross-sectional area ratio and a square ratio of hydraulic diameters in Confirmation Test 1.

FIG. 5 is a graph showing a relationship between purification performance of the catalyst base and pressure loss in Confirmation Test 1.

FIG. 6 is a graph showing a relationship between a variation in flow velocity and a cross-sectional area ratio in Confirmation Test 2.

### DESCRIPTION OF EMBODIMENTS

In the above-described catalytic converter, inner cell walls forming the inner cell holes in the inner base material part and having a thickness defined as t1, and outer cell walls forming the outer cell holes in the outer base material part and having a thickness defined as t2 are preferably configured to satisfy the relationship of t1≦t2.

In this case, the strength of the outer base material part is increased, and consequently the strength of the catalyst base is increased.

### EXAMPLE

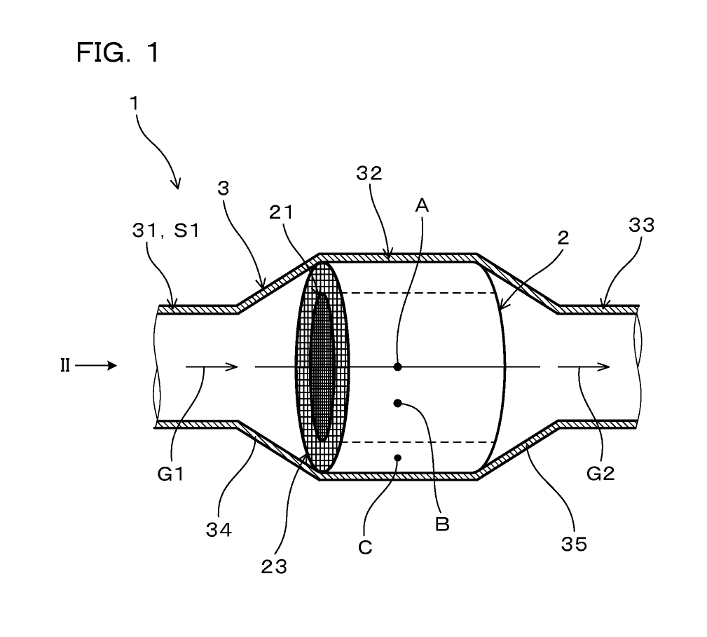

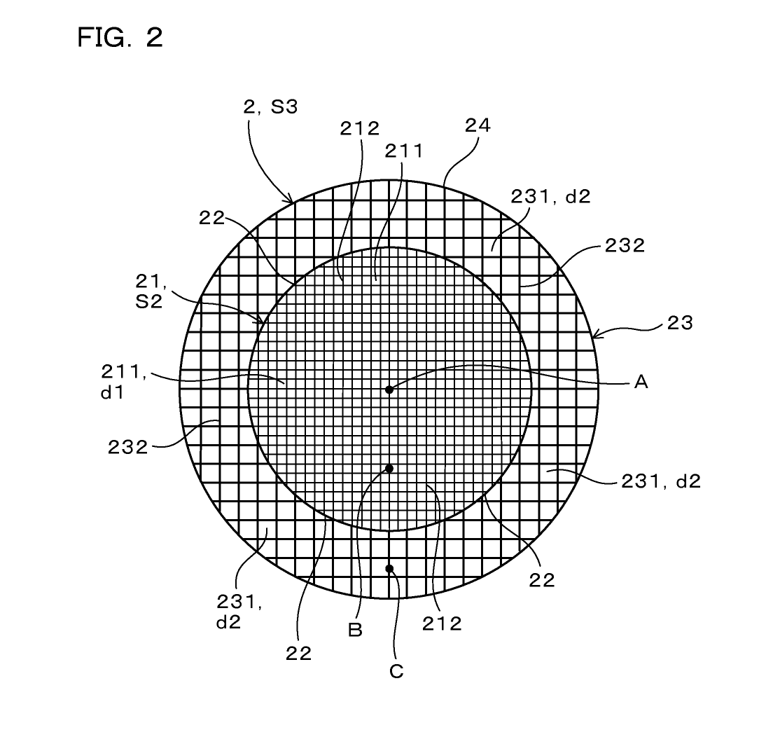

An example for the catalytic converter and method for designing the catalytic converter as described above will be described with reference to FIGS. 1 and 2.

As shown in FIGS. 1 and 2, a catalytic converter 1 according to the present example includes a catalyst base 2 for purifying an exhaust gas G1, and an exhaust pipe 3 housing the catalyst base 2.

The catalyst base 2 includes an inner base material part 21, and an outer base material part 23 formed outside the inner base material part 21. In the inner base material part 21, inner cell holes 211 that allow the exhaust gas G1 to flow therethrough are formed. In the outer base material part 23, outer cell holes 231 having a hydraulic diameter larger than that of the inner cell holes 211 are formed.

The exhaust pipe 3 includes an upstream-side pipe 31, a catalyst housing pipe 32, and a downstream-side pipe 33. The upstream-side pipe 31 allows the exhaust gas G1 generated in an internal combustion engine to flow therethrough. The catalyst housing pipe 32 is disposed downstream of the upstream-side pipe 31, has a diameter larger than that of the upstream-side pipe 31, and houses the catalyst base 2. The downstream-side pipe 33 is disposed downstream of the catalyst housing pipe 32, and allows a purified exhaust gas G2 purified with the catalyst base 2 to flow therethrough.

When a flow path cross-sectional area of the upstream-side pipe 31, a cross-sectional area of the inner base material part 21, a cross-sectional area of the catalyst base 2, a hydraulic diameter of the inner cell holes 211 and a hydraulic diameter of the outer cell holes 231 are respectively defined as S1, S2, S3, d1 and d2, the catalytic converter 1 is configured to satisfy the relationship of S1≦S2≦S3(−0.2242(d1²/d2²)²+0.1141(d1²/d2²)+0.617).

Hereinafter, the example will be described in more detail.

As shown in FIG. 1, the catalytic converter 1 of the present example is used for purifying the exhaust gas G1 generated in an engine of an automobile. The exhaust gas G1 discharged from a combustion chamber of the engine flows to the catalytic converter 1 via an exhaust gas passage (not shown).

The catalytic converter 1 includes the exhaust pipe 3 that communicates with the exhaust gas passage, and the catalyst base 2 disposed inside the exhaust pipe 3.

The exhaust pipe 3 includes the catalyst housing pipe 32 that houses the catalyst base 2, the upstream-side pipe 31 provided upstream of the catalyst housing pipe 32, and the downstream-side pipe 33 provided downstream of the catalyst housing pipe 32.

The inner diameter of the catalyst housing pipe 32 is larger than the diameters of the upstream-side pipe 31 and the downstream-side pipe 33. The catalyst base 2 is housed in the catalyst housing pipe 32. An upstream-side cone part 34 is provided between the catalyst housing pipe 32 and the upstream-side pipe 31. The upstream-side cone part 34 has a shape the diameter of which gradually changes from the diameter of the upstream-side pipe 31 to the diameter of the catalyst housing pipe 32 as it goes from the upstream-side pipe 31 side toward the catalyst housing pipe 32 side. In addition, a downstream-side cone part 35 is provided between the catalyst housing pipe 32 and the downstream-side pipe 33. The downstream-side cone part 35 has a shape the diameter of which gradually changes from the diameter of the catalyst housing pipe 32 to the diameter of the downstream-side pipe 33 as it goes from the catalyst housing pipe 32 side toward the downstream-side pipe 33 side.

As shown in FIG. 1, the upstream-side pipe 31 is in a cylindrical shape and is formed in a linear shape in the vicinity of a connection site with the upstream-side cone part 34 formed so that the center axis of the upstream-side pipe 31 is coaxial with the center axis of the catalyst housing pipe 32. The flow path cross-sectional area of the upstream-side pipe 31 is defined as S1.

Further, the downstream-side pipe 33 is in a cylindrical shape and is formed in a linear shape in the vicinity of a connection site with the downstream-side cone part 35 so that the center axis of the downstream-side pipe 33 is coaxial with the center axis of the catalyst housing pipe 32.

As shown in FIG. 2, the catalyst base 2 includes a catalyst for purifying the exhaust gas, and a cylindrical ceramic carrier that supports the catalyst. The catalyst base 2 has a honeycomb structure composed of cell walls 212 and 232 both arranged in a lattice pattern, and a plurality of cell holes 211 and 231 each partitioned by the cell walls 212 and 232. In addition, the catalyst base 2 has a cylindrical outer wall 24 that covers the outer circumferential surface thereof. The cross-sectional area of the catalyst base 2 in a cross section perpendicular to the axial direction of the catalyst base 2 is defined as S3.

The catalyst base 2 includes the inner base material part 21 formed radially inside in the cross section, and the outer base material part 23 formed radially outside the inner base material part 21. In addition, a partition wall 22 is formed between the inner base material part 21 and the outer base material part 23.

The outer base material part 23 includes a plurality of the outer cell walls 232 arranged in a lattice pattern, and a plurality of the outer cell holes 231 that are partitioned by the outer cell walls 232 and penetrate through the outer base material part 23 in the axial direction. The thickness of the outer cell walls 232 is defined as t2. Each of the outer cell holes 231 has a rectangular cross-sectional shape. A hydraulic diameter of the outer cell holes 231 is defined as d2.

The inner base material part 21 includes a plurality of the inner cell walls 212 formed in a lattice pattern, and a plurality of the inner cell holes 211 that are partitioned by the inner cell walls 212 and penetrate through the inner base material part 21 in the axial direction. The cross-sectional area of the inner base material part 21 in the cross section perpendicular to the axial direction thereof is defined as S2. The thickness of the inner cell walls 212 is defined as t1. The thickness t1 of the inner cell walls 212 and the thickness t2 of the outer cell walls 232 are set so as to satisfy the relationship of t1<t2. In addition, each of the inner cell holes 211 has a rectangular cross-sectional shape. A hydraulic diameter of the each inner cell holes is defined as d1. The hydraulic diameter d1 of the inner cell holes 211 and the hydraulic diameter d2 of the outer cell holes 231 are set so as to satisfy the relationship of d1<d2.

In the catalytic converter 1 of the present example, the dimensions of the flow path cross-sectional area S1 of the upstream-side pipe 31, the cross-sectional area S2 of the inner base material part 21, the cross-sectional area S3 of the catalyst base 2, the hydraulic diameter d1 of the inner cell holes 211 and the hydraulic diameter d2 of the outer cell holes 231 are determined so as to satisfy the relational expression of S1≦S2≦S3(−0.2242(d1²/d2²)²+0.1141(d1²/d2²)+0.617). By satisfying this relational expression, the dimensions of S1, S2, S3, d1 and d2 are determined in a balanced manner, and thereby distribution of the flow velocity of the exhaust gas G1 flowing through the catalyst base 2 can be made uniform. Thus, distribution of temperature in the catalyst base 2 can be made uniform, and the temperature of the entirety of the catalyst base 2 can be rapidly raised to the activation temperature.

Designing the catalytic converter 1 so as to satisfy the above relational expression enables the catalytic converter 1 to efficiently purify the exhaust gas G1.

In the catalytic converter 1, the inner cell walls 212 forming the inner cell holes 211 in the inner base material part 21 and having the thickness defined as t1 and the outer cell walls 232 forming the outer cell holes 231 of the outer base material part 23 and having the thickness defined as t2 are configured to satisfy the relationship of t1≦t2. Therefore, the strength of the outer base material part 23 is increased, and consequently the strength of the catalyst base 2 is increased.

(Confirmation Test 1)

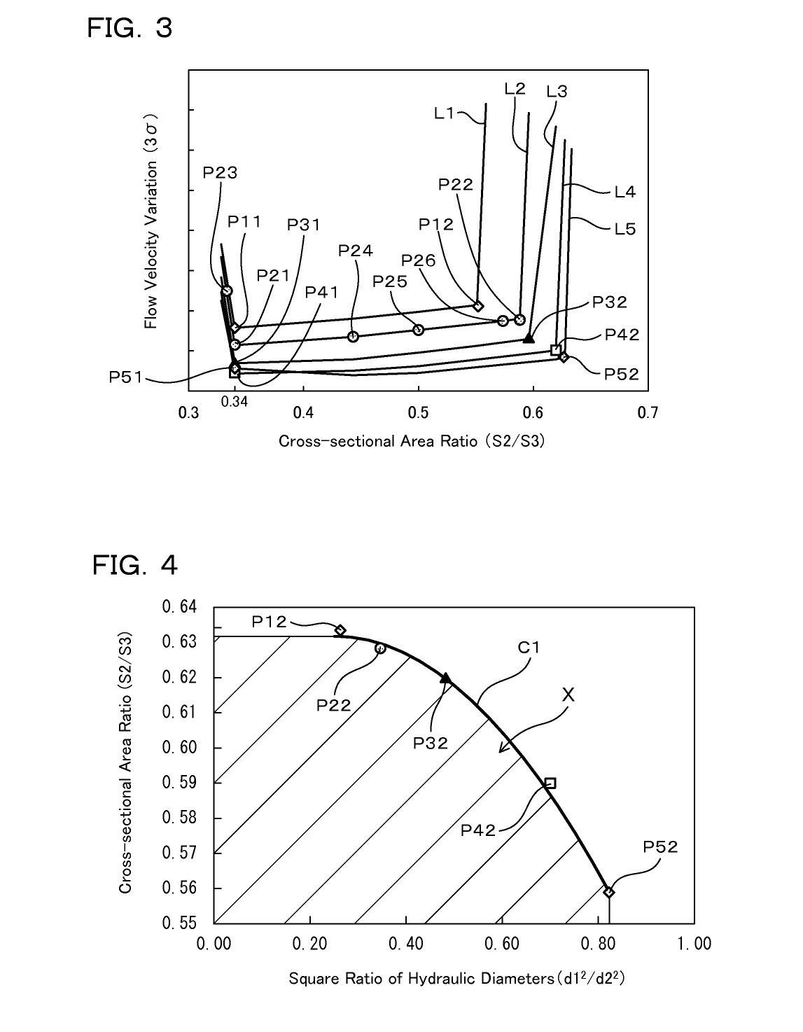

In this confirmation test, as shown in FIGS. 3 to 6, the dimensions of the hydraulic diameter d1 of the inner cell holes 211, the hydraulic diameter d2 of the outer cell holes 231 and the cross-sectional area S2 of the inner base material part 21 in the catalytic converter 1 of Example 1 were varied, and influences of the varied dimensions on flow velocity distribution, heat distribution, and purification performance were confirmed.

As for the dimensions of the catalyst base 2, the flow path cross-sectional area S1 of the upstream-side pipe 31 was 2827 mm², and the cross-sectional area S3 of the catalyst base 2 was 8332 mm². The hydraulic diameter d1 of the inner cell holes 211 and the hydraulic diameter d2 of the outer cell holes 231 in the catalyst base 2 were set so that a square ratio of hydraulic diameters (d1²/d2²), the ratio of the square of the hydraulic diameter d1 to the square of the hydraulic diameter d2 takes five values of 0.67, 0.82, 0.49, 0.35 and 0.24.

FIG. 3 is a graph showing variation in the flow velocity of the exhaust gas G1 in the catalytic converter 1 in a vertical axis, and a cross-sectional area ratio (S2/S3) indicating the ratio of the cross-sectional area S2 of the inner base material part 21 to the cross-sectional area S3 of the catalyst base 2 in a horizontal axis. In FIG. 3, solid lines L1 to L5 correspond to the catalyst bases 2 each having a different square ratio of hydraulic diameters, and indicate changes of the flow velocity variation in accordance with changes of the cross-sectional area ratio. As for the square ratio of hydraulic diameters, the solid lines L1, L2, L3, L4 and L5 corresponds to 0.82, 0.67, 0.49, 0.35 and 0.24, respectively. As for variation in flow velocity distribution, as shown in FIG. 2, the flow velocity is measured at a plurality of measurement points in the catalyst base 2 to obtain a standard deviation 3σ. Flow velocity measurement points are set at intervals of 10 mm from the center of the catalyst base 2 toward the outer circumference thereof.

As shown in FIG. 3, the solid lines L1, L2, L3, L4 and L5 form bathtub curves, and have first inflection points P11, P21, P31, P41 and P51, respectively and second inflection points P12, P22, P32, P42 and P52, respectively at which the flow velocity variation steeply changes. Between each of the first inflection points P11 to P51 and each of the second inflection points P12 to P52, the flow velocity variation is small.

At each of the first inflection points P11 to P51 of the solid lines L1 to L5, the cross-sectional area ratio is 0.34. When the cross-sectional-area ratio is 0.34, the cross-sectional area S2 of the inner base material part 21 is substantially equal to the flow path cross-sectional area S1 of the upstream-side pipe 31. In other words, the flow velocity variation is reduced when the cross-sectional area S2 of the inner base material part 21 and the flow path cross-sectional area S1 of the upstream-side pipe 31 have the relationship of S1≦S2.

FIG. 4 is a graph showing the relationship between the cross-sectional area ratio and the square ratio of hydraulic diameters at the second inflection points P12 to P52. In this graph, the cross-sectional area ratio is shown in a vertical axis and the square ratio of hydraulic diameters is shown in a horizontal axis. Curve C1 represents an approximate expression obtained from the second inflection points P12 to P52 of the solid lines L1 to L5. The approximate expression is S2/S3=(−0.2242 (d1²/d2²)²+0.1141(d1²/d2²)+0.617). In a region X where the cross-sectional area ratio is smaller than the cross-sectional area ratio obtained from the approximate expression, the flow velocity variation is reduced.

In other words, in the catalyst base 2 designed so as to satisfy the relational expression of S1≦S2≦S3 (−0.2242(d1²/d2²)²+0.1141 (d1²/d2²)+0.617), distribution of the flow velocity of the flowing exhaust gas G1 can be made uniform.

Table 1 shows distribution of temperature in the catalyst base 2 of the catalytic converter 1. The catalyst base 2 prepared for confirmation of temperature distribution has a square ratio of hydraulic diameters of 0.67, and corresponds to the solid line L2 shown in FIG. 3. The exhaust gas G1 of 400° C. was introduced into the catalytic converter 1 at a flow rate of 30 g/s, and the temperature of the catalyst base 2 was measured in each case of the cross-sectional area ratios corresponding to the points of P23, P24, P25 and P26 shown in FIG. 3. The measurement was conducted at three points, i.e., A positioned in a center of the inner base material part 21, B positioned in a side of the outer peripheral of the inner base material part 21, and C positioned in the outer base material part 23, as shown in FIGS. 1 and 2. As shown in Table 1, in the catalyst base 2, the more suppressed the flow velocity variation is, the more uniform temperature distribution can be attained.

TABLE 1

| | P₂₃ | P₂₄ | P₂₅ | P₂₆ |
|---|---|---|---|---|
| A | 250° C. | 445° C. | 440° C. | 440° C. |
| B | 400° C. | 450° C. | 425° C. | 425° C. |
| C | 430° C. | 340° C. | 300° C. | 270° C. |

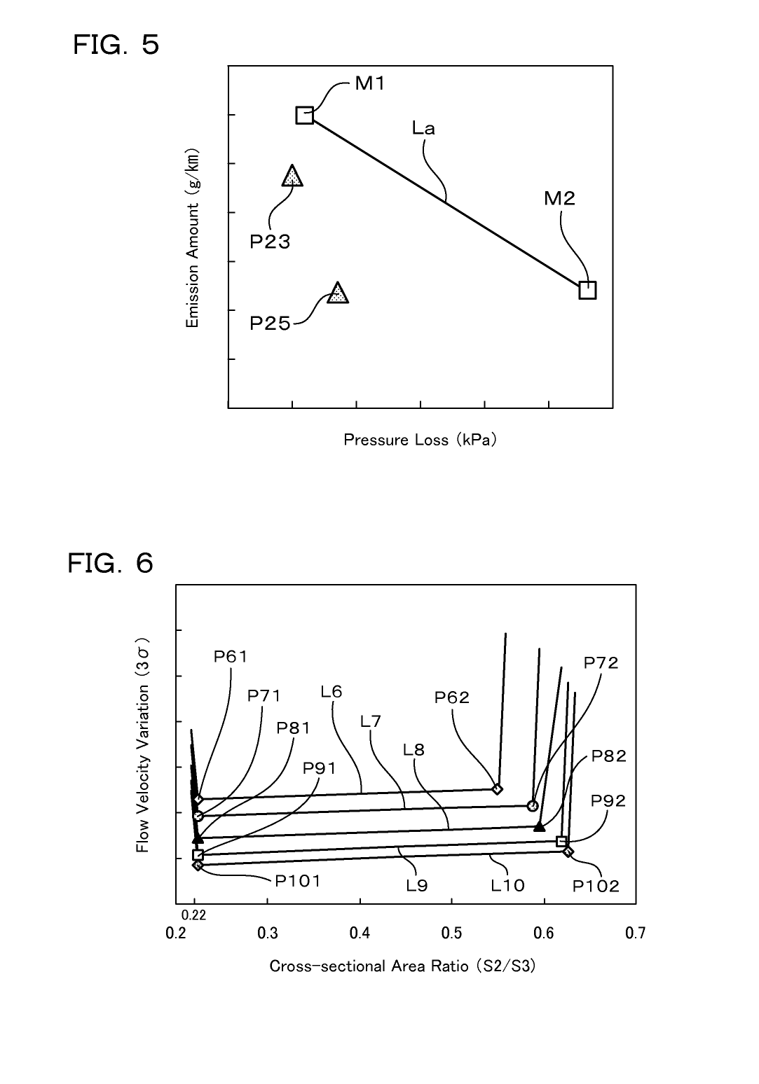

FIG. 5 is a graph showing purification performance of the catalytic converter 1 formed under the condition corresponding to the solid line L2 (FIG. 3). In this graph, an emission amount in the purified exhaust gas G2 obtained by introducing the exhaust gas G1 of 400° C. into the catalytic converter 1 at a flow rate of 30 g/s and purifying with the catalytic converter 1 is shown in a vertical axis, and a pressure loss in the catalyst base 2 is shown in a horizontal axis. The catalyst base 2 prepared for confirmation of purification performance has the same shape as the catalyst base 2 prepared for confirmation of temperature distribution, and purification performances were compared under two conditions corresponding to the cross-sectional area ratios at, i.e. P23 and P25.

In FIG. 5, a solid line La shows a relationship between the emission amount and the pressure loss exhibited in a catalyst base having uniform cell holes of which the hydraulic diameter and the number of are varied. In the catalyst base having the uniform cell holes, the purification performance is improved by reducing the hydraulic diameter of the cell holes and increasing the number of the cell holes but the pressure loss is increased. On the other hand, the pressure loss is reduced by increasing the hydraulic diameter of the cell holes and reducing the number of the cell holes but the purification performance is degraded.

As shown in FIG. 5, when the catalyst base 2 has the cross-sectional area ratio at P25, the emission amount in the purified exhaust gas G2 is reduced as compared to the case where the catalyst base 2 has the cross-sectional area ratio at P23. That is, the purification performance is improved. Further, it can be confirmed that, as compared to the solid line La, the catalyst base 2 having the cross-sectional area ratio at P25 can be improved in the purification performance while suppressing an increase in the pressure loss.

As described above, in the catalytic converter 1 designed so as to satisfy the relational expression of S1≦S2≦S3(−0.2242(d1²/d2²)²+0.1141 (d1²/d2²)+0.617), an advantageous effect to achieve uniform flow velocity in the exhaust gas can be acquired. The uniform flow velocity can realize uniform temperature distribution in the catalytic converter 1 to improve the purification performance.

(Confirmation Test 2)

The catalytic converter used in this confirmation test was prepared by partially modifying the configuration of the catalytic converter 1 used in Confirmation Test 1. In this confirmation test, the cross-sectional area S3 of the catalyst base 2 is set to 13,070 mm². The other configuration is the same as that of the catalytic converter 1 used in Confirmation Test 1.

FIG. 6 is a graph showing the relationship between a variation in the flow velocity of the exhaust gas G1 in the catalytic converter 1 and the cross-sectional-area ratio (S2/S3), the ratio of the cross-sectional area S2 of the inner base material part 21 to the cross-sectional area S3 of the catalyst base 2. In FIG. 6, solid lines L6 to L10 correspond to the catalyst bases 2 in which the hydraulic diameter d1 of the inner cell holes 211 and the hydraulic diameter d2 of the outer cell holes 231 are varied. In the solid lines L6 to L10, the square ratio of hydraulic diameters (d1²/d2²) is 0.82 for the solid line L6, 0.67 for the solid line L7, 0.49 for the solid line L8, 0.35 for the solid line L9, and 0.24 for the solid line L10.

As shown in FIG. 6, the solid lines L6, L7, L8, L9 and L10 form bathtub curves, and have first inflection points P61, P71, P81, P91 and P101, respectively and second inflection points P62, P72, P82, P92 and P102, respectively. At each of the first inflection points P61 to P101 of the solid lines L6 to L10, the cross-sectional-area ratio is 0.22. When the cross-sectional-area ratio is 0.22, the cross-sectional area S2 of the inner base material part 21 is substantially equal to the flow path cross-sectional area S1 of the upstream-side pipe 31. That is, variation in the flow velocity is reduced by setting the cross-sectional area S2 of the inner base material part 21 to be equal to or larger than the flow path cross-sectional area S1 of the upstream-side pipe 31.

In the solid lines L6 to L10, the cross-sectional area ratios for the second inflection points P62 to P102 are not fixed. Also in this confirmation test, an approximate curve plotted of the second inflection points P62 to P102 has a shape similar to the shape of the curve C1 shown in FIG. 4.

Therefore, in this confirmation test, even in the catalytic converter 1 having the different shape, an advantageous effect to achieve uniform flow velocity in the exhaust gas can be acquired by designing the catalytic converter 1 so as to satisfy the relational expression of S1≦S2≦S3(−0.2242 (d1²/d2²)²+0.1141(d1²/d2²)+0.617). The uniform flow velocity can realize uniform temperature distribution in the catalytic converter 1 to improve the purification performance.

### REFERENCE SIGNS LIST

1 catalytic converter
2 catalyst base
21 inner base material part
211 inner cell hole
23 outer base material part
231 outer cell hole
3 exhaust pipe
31 upstream-side pipe
32 catalyst housing pipe
33 downstream-side pipe

1. A method for designing a catalytic converter (1), the catalytic converter (1) comprising:
a catalyst base (2) comprising an inner base material part (21) and an outer base material part (23), the inner base material part (21) comprising inner cell holes (211) that allow an exhaust gas to flow therethrough, and the outer base material part (23) being formed outside the inner base material part (21) and comprising outer cell holes (231) each with a hydraulic diameter larger than that of the inner cell holes (211); and
an exhaust pipe (3) comprising an upstream-side pipe (31), a catalyst housing pipe (32) and a downstream-side pipe (33), the upstream-side pipe (31) allowing an exhaust gas generated in an internal combustion engine to flow therethrough, the catalyst housing pipe (32) communicating with the upstream-side pipe (31), having a diameter larger than that of the upstream-side pipe (31) and housing the catalyst base (2), and the downstream-side pipe (33) being disposed downstream of the catalyst housing pipe (32) and allowing the exhaust gas purified by the catalyst base (2) to flow therethrough,
the method comprising the step of determining dimensions of a flow path cross-sectional area of the upstream-side pipe (31) defined as S1, a cross-sectional area of the inner base material part (21) defined as S2, a cross-sectional area of the catalyst base (2) defined as S3, a hydraulic diameter of the each inner cell hole (211) defined as d1 and a hydraulic diameter of the each outer cell hole (231) defined as d2 so as to satisfy relationships of S1≦S2≦S3(−0.2242(d1²/d2²)²+0.1141(d1²/d2²)+0.617) and 0.24≦(d1²/d2²)²≦0.82.

2. A catalytic converter (1) comprising:
a catalyst base (2) comprising an inner base material part (21) and an outer base material part (23), the inner base material part (21) comprising inner cell holes (211) that allow an exhaust gas to flow therethrough, and the outer base material part (23) being formed outside the inner base material part (21) and comprising outer cell holes (231) each with a hydraulic diameter larger than that of the inner cell holes (211); and
an exhaust pipe (3) comprising an upstream-side pipe (31), a catalyst housing pipe (32) and a downstream-side pipe (33), the upstream-side pipe (31) allowing an exhaust gas generated in an internal combustion engine to flow therethrough, the catalyst housing pipe (32) communicating with the upstream-side pipe (31), having a diameter larger than that of the upstream-side pipe (31) and housing the catalyst base (2), and the downstream-side pipe (33) being disposed downstream of the catalyst housing pipe (32) and allowing the exhaust gas purified by the catalyst base (2) to flow therethrough, wherein
a flow path cross-sectional area of the upstream-side pipe (31) defined as S1, a cross-sectional area of the inner base material part (21) defined as S2, a cross-sectional area of the catalyst base (2) defined as S3, a hydraulic diameter of the each inner cell hole (211) defined as d1 and a hydraulic diameter of the each outer cell hole (231) defined as d2, satisfy relationships of S1≦S2≦S3(−0.2242(d1²/d2²)²+0.1141(d1²/d2²)+0.617) and 0.24≦(d1²/d2²)²≦0.82.

3. The catalytic converter (1) according to claim 2, wherein inner cell walls (212) forming the inner cell holes (211) in the inner base material part (21) and having a thickness defined as t1, and outer cell walls (232) forming the outer cell holes (231) in the outer base material part (23) and having a thickness defined as t2 are configured to satisfy the relationship of t1≦t2.
